(19) United States
(12) Patent Application Publication
(10) Pub. No.: US 2026/0161037 A1
(43) Pub. Date: Jun. 11, 2026

(54) VARIABLE OPTICAL ATTENUATOR (VOA) FOR HIGH OPTICAL POWER HANDLING

(71) Applicant: Molex, LLC, Lisle, IL (US)

(72) Inventors: Gongjian Hu, Seaside, CA (US); Lifu Gong, San Jose, CA (US)

(21) Appl. No.: 19/178,953

(22) Filed: Apr. 15, 2025

Related U.S. Application Data
(60) Provisional application No. 63/640,208, filed on Apr. 30, 2024.

(51) Int. Cl. G02F 1/139; G02B 27/30; G02F 1/1335; G02F 1/13363

(52) U.S. Cl. CPC G02F 1/1396; G02B 27/30; G02F 1/133526; G02F 1/13355; G02F 1/13363

(57) ABSTRACT

A system and method for implementing a Variable Optical Attenuator (VOA) for high optical power handling. The VOA device may include an optical signal attenuation element with a fixed optical path to dump unwanted optical light to a light absorption material. The light absorption material may be thermally managed for reliability. The VOA device may support input light beams having any polarization state or composites of both P and S light. An embodiment of the present invention is directed to managing P light and S light through the VOA device to travel within a same optical path length to minimize Polarization Mode Dispersion (PMD). In addition, P and S polarization beams may be independently attenuated to minimizes Polarization Dependent Loss (PDL).

### FIELD OF THE INVENTION

The present disclosure relates to the field of optical attenuators, and more particularly but not exclusively, to the field of variable optical attenuators (VOA) for high optical power handling.

### BACKGROUND

In optical networks, Variable Optical Attenuators (VOA) are widely used to manipulate optical signals to a desired power level. There are various technologies for VOA implementation, such as light scattering, light absorption, and light steering, etc. A common technique involves using a micro-electro-mechanical systems (MEMS) based mirror to steer light off a nominal path to achieve attenuation variation. VOAs are commonly used in telecom and data applications.

At an attenuation mode, unwanted optical light may be dissipated in a fiber cladding and the surroundings of an output optical collimator or the device itself. This is generally not a problem for a traditional telecom applications where optical signal power typically is lower than 500 mW or 1 W. However, performance degradation or other reliability issues emerge when optical power increases higher than 1 W, as unwanted optical light will deform or even burn or otherwise damage any material that the light encounters. In a MEMS based VOA, there is also some light absorption at the mirror itself. In this implementation, a mirror hinge of the MEMS is generally thin and not a good conductor of heat.

As new fiber types and applications are introduced requiring higher bandwidths, there is an increase in optical signals within a fiber. This may be driven by applications relating to Artificial Intelligence (AI)/Machine Learning (ML). With current technologies, optical components are not able to handle this increase in power without performance and reliability issues.

It would be desirable, therefore, to have a system and method that could overcome the foregoing disadvantages of known systems.

### SUMMARY

According to an embodiment, the invention relates to a variable optical attenuator device that supports high optical power handling. The variable optical attenuator device comprises: an input optical collimator that receives an optical beam comprising one or a combination of: first and second polarization states; an attenuation element that receives the optical beam from the input optical collimator, wherein the attenuation element comprises a first light manipulation element that changes polarization state and a second light manipulation element that transmits an attenuated optical beam along a signal path and further transmits unwanted light along a fixed path to a light absorption material and a thermal management element; and an output optical collimator that receives the attenuated optical beam from the attenuation element.

According to an embodiment, the invention relates to a method for implementing a variable optical attenuator device that supports high optical power handling. The method comprises the steps of: receiving, via an input optical collimator, an optical beam comprising one or a combination of: first and second polarization states; receiving, via an attenuation element, the optical beam from the input optical collimator, wherein the attenuation element comprises a first light manipulation element that changes polarization state; transmitting, via a second light manipulation element, an attenuated optical beam along a signal path; transmitting unwanted light along a fixed path to a light absorption material and a thermal management element; and receiving, via an output optical collimator, the attenuated optical beam from the attenuation element.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIGS. 1A-1C are exemplary diagrams of an optical device with a MEMS Mirror

FIG. 2A is an exemplary diagram of a variable optical attenuator, according to an embodiment of the present invention.

FIG. 2B illustrates an Optical Signal Attenuation Element, according to an embodiment of the present invention.

FIG. 3 illustrates a detailed view of a Variable Optical Attenuator, according to an embodiment of the present invention.

FIG. 4 is a detailed illustration of a Variable Optical Attenuator, according to an embodiment of the present invention.

FIGS. 5A and 5B illustrate a transmissional LC polarization modulator, according to an embodiment of the present invention.

FIGS. 6A and 6B illustrate LC rise time and LC settling time, according to an embodiment of the present invention.

FIG. 7 illustrates an array implementation, according to an embodiment of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will, however, be apparent to those skilled in the art that these concepts may be practiced without these specific details. In some instances, well known structures and components are shown in block diagram form in order to avoid obscuring such concepts.

An optical attenuator generally refers to a device that reduces or otherwise manipulates a power level of an optical signal in free space or in an optical fiber. Variable optical attenuators may adjust a level or degree of attenuation through an electrical signal. Accordingly, variable optical attenuators may be used in various applications including optical fiber communications, telecom systems, etc.

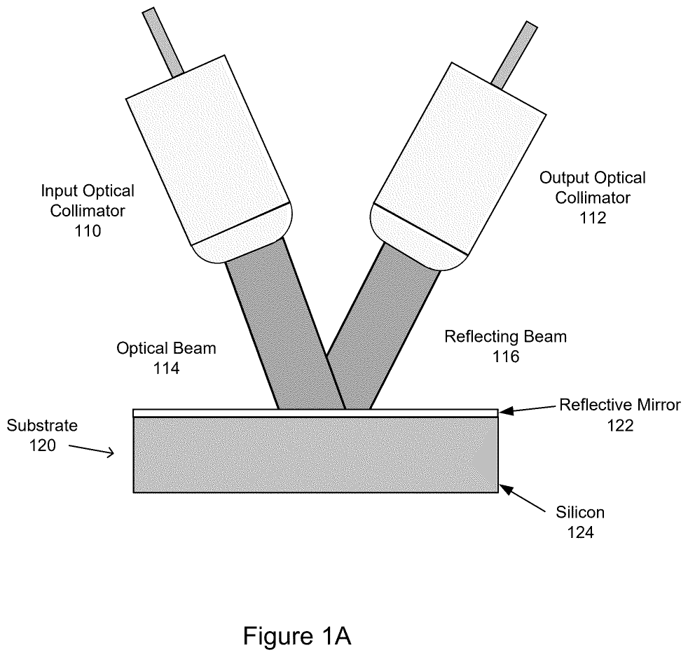

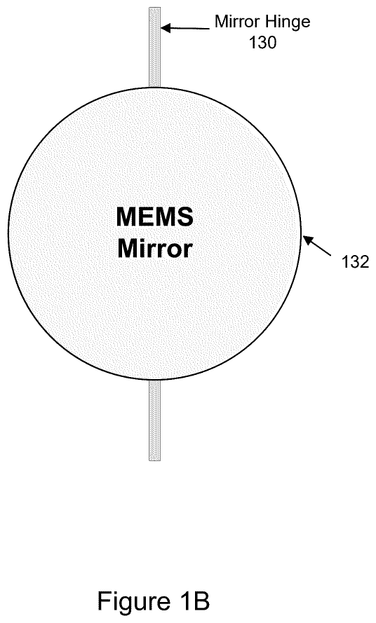

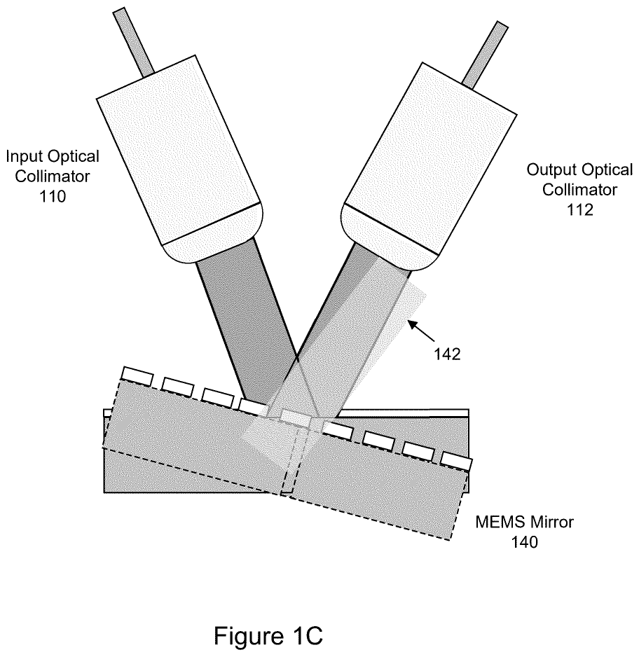

FIGS. 1A-1C are exemplary diagrams of an optical device. FIG. 1A illustrates an optical device with a micro-electro-mechanical systems (MEMS) MEMS Mirror at a nominal position. As shown in FIG. 1A, an Input Optical Collimator 110 directs an optical beam 114 to a substrate 120 where the optical beam 114 is then reflected, as shown by Reflecting Beam 116, to an Output Optical Collimator 112. The Input and Output collimators may include a fiber array for receiving or transmitting optical signals. In this illustration, the light coupling is optimal from the input to the output and attenuation is at a minimum. The substrate 120 may include a silicon base 124 and a Gold or Aluminum plated reflection mirror 122 which may account for approximately 1-2% optical loss. Other materials may be implemented for the substrate as well as the reflective mirror.

FIG. 1B illustrates a top view of the MEMS Mirror in FIG. 1A. The MEMS Mirror 132 has a very thin mirror hinge 130. As shown in FIG. 1B, the mirror hinge 130 serves as the only connection for heat conduction to the substrate.

FIG. 1C illustrates an optical device with a MEMS Mirror in a tilted position. As shown in FIG. 1C, the MEMS Mirror 140 is tilted for attenuation where the optical beam is off the optimal optical path of an Output Optical Collimator, as shown by 142.

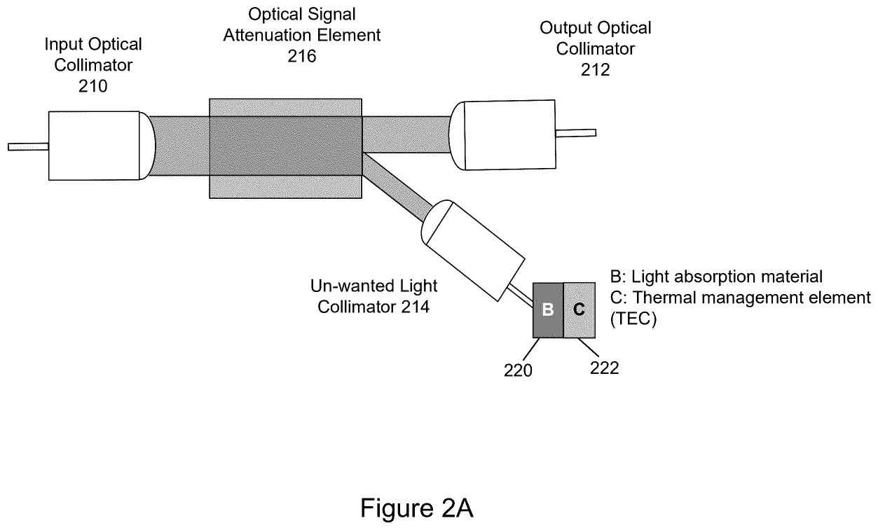

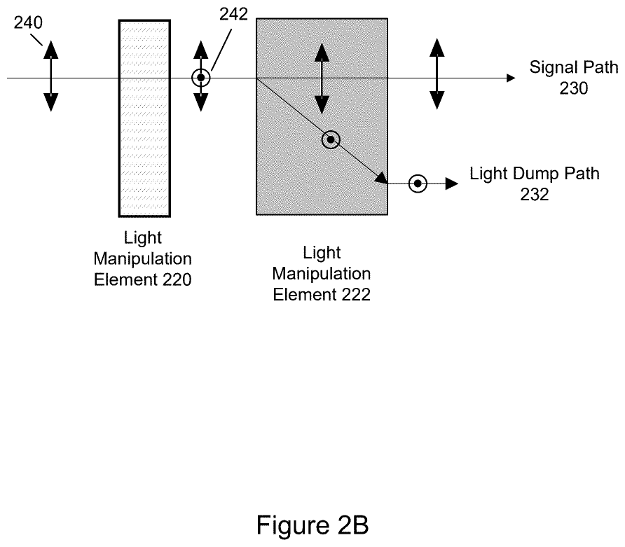

FIG. 2A is an exemplary diagram of a variable optical attenuator, according to an embodiment of the present invention. An embodiment of the present invention is directed to a variable optical attenuator (VOA) for high optical power handling. The VOA may be designed to control unwanted optical light to minimize any impact that may be encountered in the device itself. In this embodiment, the optical path may be fixed rather than variant.

FIG. 2A illustrates a VOA having a fixed optical path. An Input Optical Collimator 210 may transmit an optical beam through an Optical Signal Attenuation Element 216 to an Output Optical Collimator 212. The optical beam received by the Output Optical Collimator 212 represents the light signal after attenuation. As shown by FIG. 2A, unwanted light may be directed to an Unwanted Light Collimator 214 that may include a Light Absorption Material 220 and a Thermal Management Element 222, and one example of such Thermal Management Element is Thermoelectric Cooler (TEC).

As shown in FIG. 2A, unwanted optical light may dissipate into a Light Absorbing Material 220 which may include a Black-Out Material with very low reflectivity. The light absorbing black-out material or film may be thermally managed to control its temperature through a thermal management element 222 which may include a thermoelectric cooler (TEC) or natural air. Photons may contribute to a rising of the temperature of the light absorbing black-out material.

An embodiment of the present invention is directed to thermal management and signal management that efficiently handles wasted light signal energy. Thermal and signal management is directed to improving component performance and reliability. The TEC removes thermal energy out and transfer the thermal energy to a heat sink to dissipate heat outside of the device. The heat sink may include aluminum, copper or other heat dissipating material.

FIG. 2B illustrates an Optical Signal Attenuation Element, according to an embodiment of the present invention. Optical Signal Attenuation Element, as shown by 216 in FIG. 2A, may include a Light Manipulation Element 220 and a Light Manipulation Element 222 that supports a Signal Path 230 and a Light Dump Path 232 which may be fixed. In the exemplary illustration, FIG. 2B shows an input light with P polarization state as shown by 240.

The Light Manipulation Element 220 may change the light polarization to a different polarization state. For example, 220 may include a Liquid Crystal Cell. A signal with only P polarization state (shown by 240) may have S polarization state (as shown by 242) where the density of S polarization light may depend on different electro-optical characterizations of the Liquid Crystal Cell material, represented by 220. After passing Light Manipulation Element 222, the P polarization state light may continue on a signal path 230. Light Manipulation Element 222 may include a birefringent optical crystal, such as Yttrium Vanadate (YVO4). Other materials may be implemented. As shown in FIG. 2B, the P polarization state light may be attenuated (as represented by Signal Path 230), while the S polarization state light continues to another fixed path, shown by Light Dump Path 232, to be dumped to a light absorption material, shown as 220 in FIG. 2A.

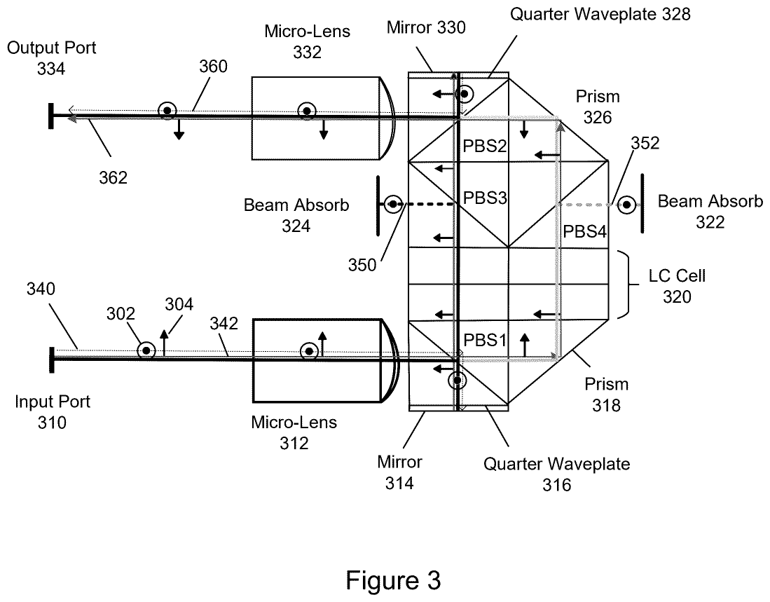

FIG. 3 illustrates a detailed view of a Variable Optical Attenuator, according to an embodiment of the present invention.

The VOA device may support input light beams having any polarization state or composites of both P and S light. An embodiment of the present invention is directed to managing P light and S light through the VOA device to travel within a same optical path length. This minimizes Polarization Mode Dispersion (PMD), Polarization Dependent Loss (PDL), etc. FIG. 3 illustrates an exemplary implementation of a VOA that handles large optical power while avoiding or minimizing light damage and other reliability or performance issues.

As shown in FIG. 3, Input Port 310 may include a Fiber Pigtail (not shown) and Micro-Lens 312. On the other end, Output Port 334 may include a Fiber Pigtail (not shown) and Micro-Lens 332.

A Polarization Separator/Combiner may include 4× PBS rhombs, as represented by PBS1, PBS2, PBS3 and PBS 4. Polarizing Beam Splitters (PBS) may operate to multiplex/de-multiplex light beams with polarization directions perpendicular to each other.

A Polarization Rotator may include two quarter wave plates, shown by Quarter Waveplate 316 and Quarter Waveplate 328. A Quarter Waveplate alters the polarization state of a light wave travelling through it and converts between different elliptical polarizations. This may involve converting from linearly polarized light to circularly polarized light and vice-versa.

A Polarization Modulator may include a Twisted Nematic (TN) Liquid Crystal (LC) cell, as shown by LC Cell 320, which may include an electronically controlled birefringence (ECB) cell with minor design change. TN cells generally represent 90 degree liquid crystal polarization rotators. As linear polarized light enters the cell, it rotates along the LC helical structure formed from the front to the back substrate. ECB may use an applied voltage to change the tilt of the liquid crystal molecules resulting in a change in the birefringence.

A Beam Folder may include two prisms, represented by Prism 318 and Prism 326, to fold or direct the light beam.

Two Beam Absorbs, represented by Beam Absorb 322 and Beam Absorb 324, may be used to absorb the dumped light. Beam Absorbs 322 and 324 may include a light absorption material with a thermal management element.

As shown in FIG. 3, an input port 310 may receive an incoming optical beam that is with two polarizations, S and P polarizations, and passed through Micro-Lens 312. S polarization is shown by circle symbol 302 and P polarization is shown by an arrow symbol 304. The VOA of an embodiment of the present invention may support input light beams having both P and S polarizations with combination ratio from 100% to 0. PBS1 may separate the incoming optical beam into two separate beams - P and S polarization beams. An optical beam 342 having P polarization may be directed through Micro-Lens 312 and then through PBS1, as shown by the arrow symbol. The optical beam 340 with S polarization is reflected by PBS1 to Mirror 314 and then back through Mirror 330 and then directed by PBS2 to Micro Lens 332 to an Output Port 334.

The S polarization beam 340 may be reflected by Mirror 314 and then converted into P polarization, as shown by the arrow symbol, by a double pass through Quarter Waveplate 316. Quarter-waveplates may be used to turn linearly polarized light into circularly polarized light and vice versa. The converted P polarization beam may be reflected by Mirror 330 and then converted back into S polarization by a double pass through Quarter Waveplate 328, and then directed to the Output Port 334, as shown by optical beam 360.

The P polarization beam, as shown by beam 342 and the arrow symbol, may be directed by Prism 318 to Prism 326 and then directed through PBS2 to Micro-Lens 332 to Output Port 334, as shown by optical beam 362. This configuration ensures that the optical path length taken by optical beam having polarization S is the same (or substantially the same) as the optical path taken by optical beam having polarization P.

FIG. 3 illustrates Quarter Waveplates 316 and 328. Quarter Waveplate may represent a polarization rotator that alters a polarization state by 45 degrees. The structure of FIG. 3 supports a double pass resulting in a 90 degree polarization shift. Light reflected back after the waveplate will do a double pass through it, effectively as a half wave plate. The polarization direction is rotated by 90 degree. For example, the optical beam may pass the Quarter Waveplate 316 and then reflect back from Mirror 314 and further pass through Quarter Waveplate 316 for a second time. In a similar manner on the other end, the optical beam may pass through Quarter Waveplate 328 and then reflect back from Mirror 330 and further pass through Quarter Waveplate 328 for a second time.

As shown in FIG. 3, the optical beam having polarization S and the optical beam having a perpendicular polarization P may pass through an LC Cell 320. The LC Cell 320 may further manipulate the polarization of the optical beams. In this implementation, the LC Cell 320 may rotate polarization. For example, some portion of the optical beam having polarization S may convert to polarization P through PBS3 and another portion shown by 352 may be pushed to Beam Absorb 322. In addition, the optical beam having polarization P may pass through the LC Cell 320 where a portion of the optical beam may convert to polarization S and pass through PBS4 and another portion shown by 350 may be pushed to Beam Absorb 324.

LC Cell 320 may support TN mode or ECB mode. As noted above, TN cells generally represent 90 degree liquid crystal polarization rotators and ECB may use an applied voltage to change the tilt of the liquid crystal molecules resulting in a change in the birefringence. Other modes may be supported.

An embodiment of the present invention may support higher power silicon substrates with a thermal conductivity that is higher than glass. Other materials with thermal conductivity properties may be implemented as well.

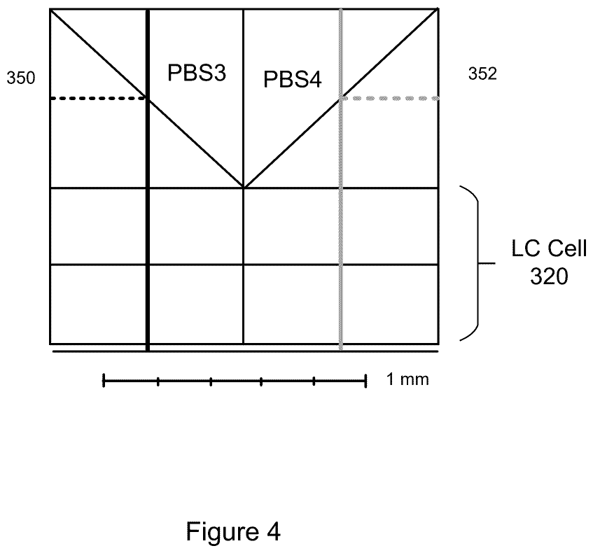

FIG. 4 is a detailed illustration of a Variable Optical Attenuator, according to an embodiment of the present invention. FIG. 4 illustrates implementation details of LC Cell 320.

As shown in FIG. 4, the LC Cell 320 may include a glass/silicon substrate (approximately 0.3 mm thick), an ECB/TN LC Layer and a glass/silicon substrate (approximately 0.3 mm thick). When a LC Polarization modulator rotates both beam polarizations into S state, the beam may be reflected by PBS3 and PBS4, as shown by 350 and 352 respectively, and then blocked by Beam Absorbs as dumped light. The energy that is attenuated may pass to Beam Absorbs.

An embodiment of the present invention is directed to minimizing system PDL. The LC Cell 320 may manipulate light polarization states. Because the two polarization states are separate, their attenuation may also be adjusted separately. An embodiment of the present invention may implement multiple LC cells, such as two LC cells that may be independently controlled to balance and thereby minimize PDL. For example, one LC cell may control one polarization while the other LC cell may control the other polarization.

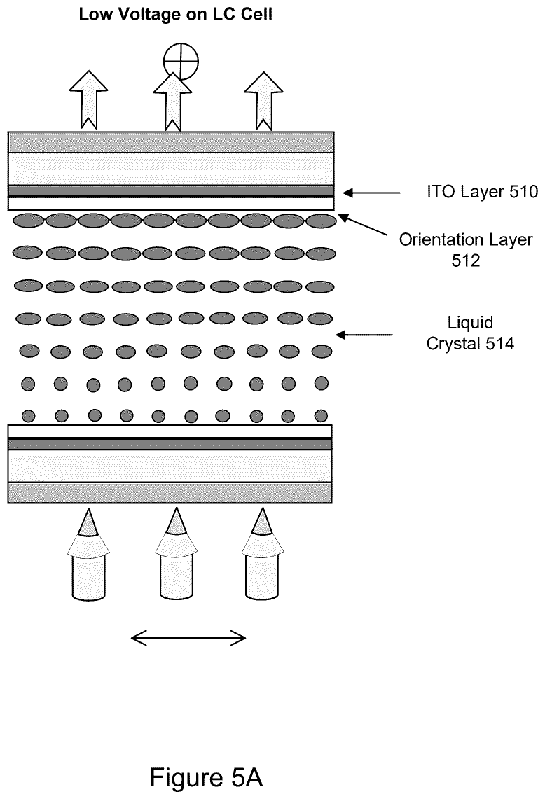

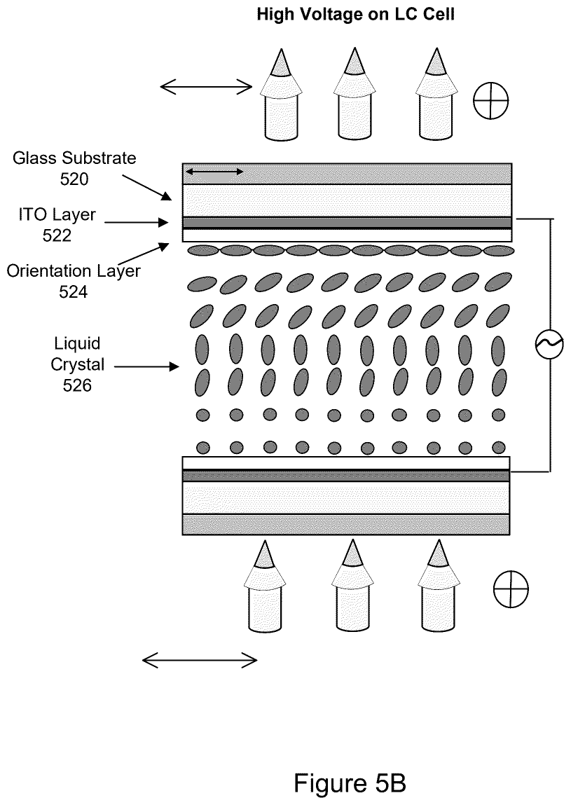

FIGS. 5A and 5B illustrate a transmissional LC polarization modulator, according to an embodiment of the present invention. FIG. 5A illustrates a low voltage on LC cell while FIG. 5B illustrates a high voltage on LC cell.

FIG. 5A illustrates an ITO layer 510, orientation layer 512 and liquid crystal 514. ITO layer 510 may represent a transparent conducting oxide including indium, tin and oxygen.

FIG. 5B illustrates a glass substrate 520, ITO layer 522, orientation layer 524 and liquid crystal 526.

As shown in FIG. 5A, the linear polarization of an incidental beam may rotate 90 degree when a low voltage is applied on a TN cell. Without an applied voltage, LC cell is aligned at 45 degrees from a horizontal plane where the LC cell may function as a half waveplate so that horizontal polarization will rotate in a vertical direction when a beam passes through the LC cell. Under a high voltage, the output polarization is the same as input one, as shown in FIG. 5B. The LC cell may be aligned vertically to the cell substrate's surface where the beam has zero birefringence (no waveplate) and the beam polarization remains the same.

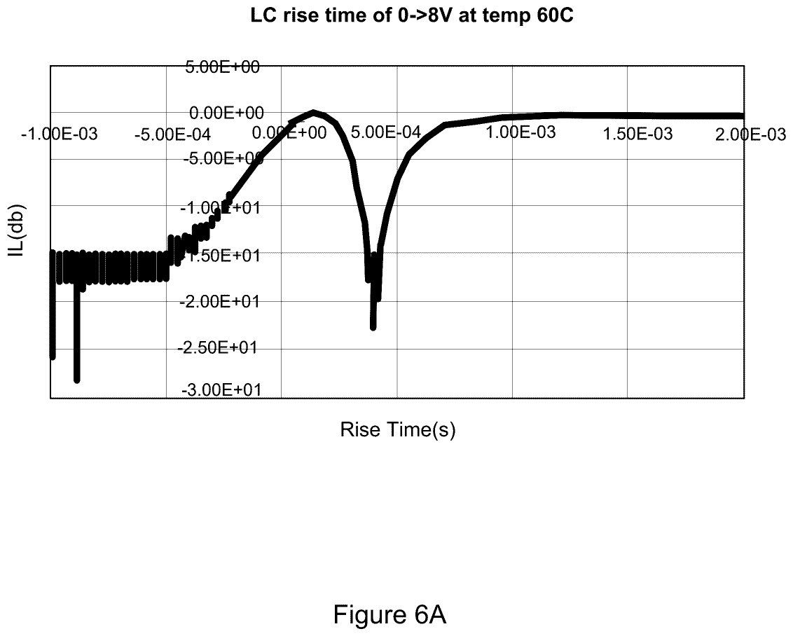

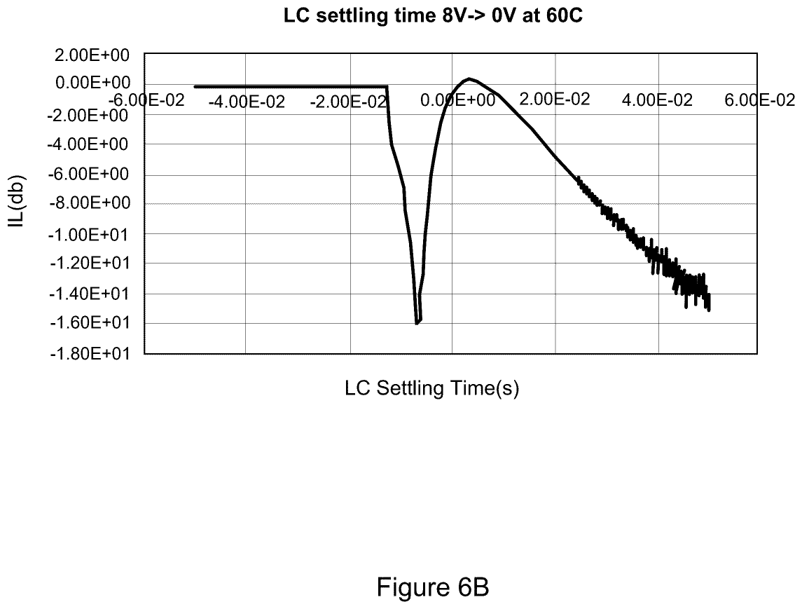

FIGS. 6A and 6B illustrate LC rise time and LC settling time, according to an embodiment of the present invention. At temperature 60 C, LC rise time is 1.8 milliseconds (ms) while LC settling time is 61 ms.

FIG. 6A illustrates LC rise time of 0->8V at temperature 60 C.

FIG. 6B illustrates LC settling time of 8->0V at temperature 60 C.

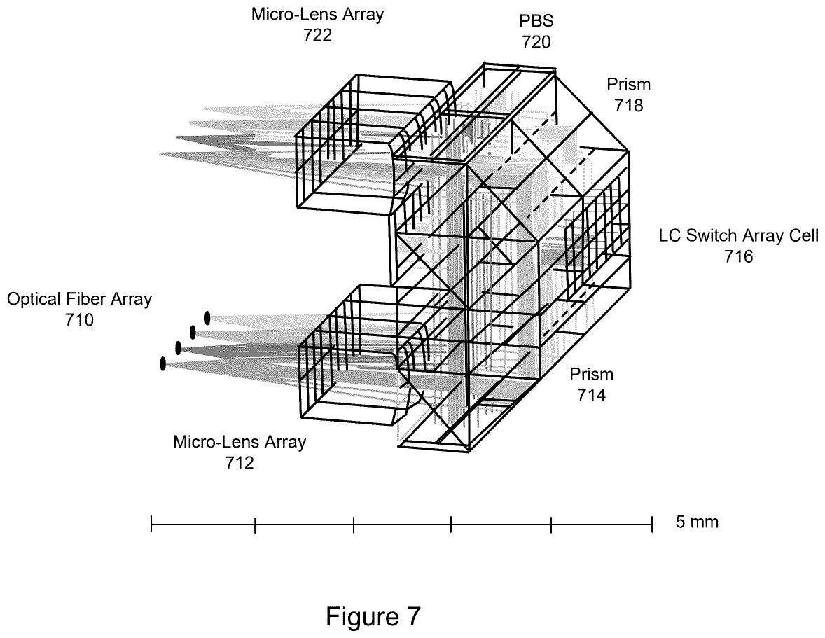

FIG. 7 illustrates an array implementation, according to an embodiment of the present invention. The VOA structure may be expanded to be an array device. FIG. 7 illustrates four VOAs for illustration but any number of VOAs may be implemented. The array may be controlled in parallel as well as in sequence. Each VOA structure may be controlled or manipulated independently within the array structure. The array structure may be scaled to support various high power applications.

As shown in FIG. 7, an Optical Fiber Array 710 may transmit parallel optical beams to Micro Lens Array 712, through Prism 714, LC Switch Array 716, Prism 718 and Micro Lens Array 722. The array structure may also include corresponding PBS devices represented by PBS 720.

An embodiment of the present invention may be scaled to support an array of attenuators depending on the application. The structure may be combined with other optical components, such as a multiplexer or demultiplexer. In addition, an embodiment of the present invention may attenuate each channel or each wavelength using a separate attenuator. Accordingly, the structure is versatile and may support various applications and uses.

According to an embodiment of the present invention, a Variable Optical Attenuator (VOA) device may include an optical signal attenuation element with a fixed optical path to dump unwanted optical light to a light absorption material. The light absorption material may be thermally managed for reliability.

According to an embodiment of the present invention, a VOA structure may include: an Input Port, an Output Port, 4× PBS rhombs for Polarization Separating/Combining, 2× Quarter Waveplates as a Polarization Rotator, TN LC Cell as a Polarization Modulator, 2× Prisms to fold optical beams, and 2 Beam Absorbs to absorb the dumped light which may be thermally managed. Other variations to the VOA structure may be supported.

In this implementation, both Input and Output Ports may include a Fiber Pigtail and Micro-Lens where both may be arranged on the same side of the device to reduce the footprint. The light path for P and S polarizations may be balanced to minimize PMD. In addition, P and S polarization beams may be independently attenuated to minimize possible PDL. An embodiment of the present invention may also support various configurations, including an array structure.

Polarization Mode Dispersion (PMD) may represent a form of modal dispersion where two different polarizations of light in an optical device travel a different speeds due to imperfections, asymmetries and other randomness. This causes random spreading of optical pulses and other irregularities. Unless properly addressed, this may result in inefficiencies in data rates. An embodiment of the present invention is directed to minimizing PMD (which generally occurs when there is a separation between two polarizations) by ensuring that the light path lengths for each optical beam is the same (or substantially the same).

Polarization Dependent Loss (PDL) may represent a loss that varies as the polarization state of a propagating wave changes in optical components. PDL may be expressed as a difference between a maximum and minimum loss in decibels.

An embodiment of the present invention may support various high power applications that use a range of optical fiber types. High power applications may include AI/ML applications and systems. For example, low latency fiber types may include hollow core fibers that represent optical fibers that guide light within a hollow region, so that only a minor portion of the optical power propagates in the solid fiber material. Low latency fiber types may support high power (e.g., greater than 1 W) and large bandwidth applications and multiple bands, including C Band, L Band, S Band. Accordingly, hundreds and hundreds of channels may be supported.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

It will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A variable optical attenuator device comprising:
an input optical collimator that receives an optical beam comprising one or a combination of: first and second polarization states;
an attenuation element that receives the optical beam from the input optical collimator, wherein the attenuation element comprises a first light manipulation element that changes polarization state and a second light manipulation element that transmits an attenuated optical beam along a signal path and further transmits unwanted light along a fixed path to a light absorption material and a thermal management element; and
an output optical collimator that receives the attenuated optical beam from the attenuation element.

2. The variable optical attenuator device of claim 1, wherein the first light manipulation element comprises a liquid crystal cell.

3. The variable optical attenuator device of claim 2, wherein the liquid crystal cell comprises: a Twisted Nematic (TN) cell and an electronically controlled birefringence (ECB) cell.

4. The variable optical attenuator device of claim 1, the second light manipulation element comprises a birefringent optical crystal.

5. The variable optical attenuator device of claim 1, wherein the variable optical attenuator device is configured in an array structure.

6. The variable optical attenuator device of claim 1, wherein the attenuation element comprises: a first micro lens that receives the optical beam, a first Polarizing Beam Splitter (PBS) that receives the optical beam and transmits a first polarization beam to a first mirror and a first quarter waveplate combination that alters the first polarization beam to a second polarization beam; a second PBS that receives the second polarization beam and transmits to a second mirror and a second quarter waveplate combination that alters the second polarization beam to the first polarization beam which is then transmitted through the second PBS and a second micro lens to the output optical collimator.

7. The variable optical attenuator device of claim 6, wherein the first PBS receives the optical beam and transmits a second polarization beam of the optical beam to a first prism which transmits the second polarization beam of the optical beam to a second prism which then transmits the second polarization beam through the second PBS to the second micro lens.

8. The variable optical attenuator device of claim 7, wherein a third PBS receives a first portion of the second polarization beam from the first PBS and transmits the first portion to a first beam absorb component and wherein a fourth PBS receives a second portion of the first polarization beam from the first prism and transmits the second portion to a second beam absorb.

9. The variable optical attenuator device of claim 1, wherein the attenuation element supports a first optical path of a first polarization beam and a second optical path of a second polarization beam as being substantially the same in optical length to minimize polarization mode dispersion (PMD).

10. The variable optical attenuator device of claim 1, wherein the attenuation element independently attenuates a first polarization beam and a second polarization to minimize polarization dependent loss (PDL).

11. A method for implementing a variable optical attenuator device, the method comprising the steps of:
receiving, via an input optical collimator, an optical beam comprising one or a combination of: first and second polarization states;
receiving, via an attenuation element, the optical beam from the input optical collimator, wherein the attenuation element comprises a first light manipulation element that changes polarization state;
transmitting, via a second light manipulation element, an attenuated optical beam along a signal path;
transmitting unwanted light along a fixed path to a light absorption material and a thermal management element; and
receiving, via an output optical collimator, the attenuated optical beam from the attenuation element.

12. The method of claim 11, wherein the first light manipulation element comprises a liquid crystal cell.

13. The method of claim 12, wherein the liquid crystal cell comprises: a Twisted Nematic (TN) cell and an electronically controlled birefringence (ECB) cell.

14. The method of claim 11, the second light manipulation element comprises a birefringent optical crystal.

15. The method of claim 11, wherein the variable optical attenuator device is configured in an array structure.

16. The method of claim 11, wherein the attenuation element comprises: a first micro lens that receives the optical beam, a first Polarizing Beam Splitter (PBS) that receives the optical beam and transmits a first polarization beam to a first mirror and a first quarter waveplate combination that alters the first polarization beam to a second polarization beam; a second PBS that receives the second polarization beam and transmits to a second mirror and a second quarter waveplate combination that alters the second polarization beam to the first polarization beam which is then transmitted through the second PBS and a second micro lens to the output optical collimator.

17. The method of claim 16, wherein the first PBS receives the optical beam and transmits a second polarization beam of the optical beam to a first prism which transmits the second polarization beam of the optical beam to a second prism which then transmits the second polarization beam through the second PBS to the second micro lens.

18. The method of claim 17, wherein a third PBS receives a first portion of the second polarization beam from the first PBS and transmits the first portion to a first beam absorb component and wherein a fourth PBS receives a second portion of the first polarization beam from the first prism and transmits the second portion to a second beam absorb.

19. The method of claim 16, wherein the attenuation element supports a first optical path of a first polarization beam and a second optical path of a second polarization beam as being substantially the same in optical length to minimize polarization mode dispersion (PMD).

20. The method of claim 16, wherein the attenuation element independently attenuates a first polarization beam and a second polarization to minimize polarization dependent loss (PDL).
